(19) United States
(12) Patent Application Publication
(10) Pub. No.: US 2023/0373037 A1
(43) Pub. Date: Nov. 23, 2023

(54) Flux-cored wire and corresponding method for welding metals

(71) Applicant: VERDICIO SOLUTIONS A.I.E., Madrid (ES)

(72) Inventors: Alvaro MANJON FERNANDEZ, Oviedo Asturias (ES); Marcos PEREZ RODRIGUEZ, Cangas Del Narcea Asturias (ES); Roberto SUAREZ SANCHEZ, Avilés Asturias (ES); Christopher GERRITSEN, Sint-Amandsberg (Gent) (BE)

(21) Appl. No.: 18/031,492

(22) PCT Filed: Oct. 21, 2020
(86) PCT No.: PCT/IB2020/059876

§ 371 Date: Apr. 12, 2023

(51) Int. Cl. B23K 35/02; B23K 35/36; B23K 35/362; B23K 35/40

(52) U.S. Cl. CPC B23K 35/0266; B23K 35/3608; B23K 35/362; B23K 35/406

(57) ABSTRACT

A flux-cored wire including a sheath and a flux that fills the sheath, wherein the flux includes a titanate and a nanoparticulate oxide selected from the group consisting of TiO₂, SiO₂, ZrO₂, Y₂O₃, Al₂O₃, MoO₃, CrO₃, CeO₂, La₂O₃ and mixtures thereof.

The present invention relates to the welding of metallic substrates with flux-cored wires. It also relates to the method for the manufacture of the flux-cored wire. It is particularly well suited for construction, shipbuilding, transportation industry (rail and automotive), energy-related structures, oil&gas and offshore industries.

### BACKGROUND

It is known to weld metallic substrates with a filler wire notably when a gap has to be filled. The filler wire can feed the weld from the side (as in Gas Tungsten Arc Welding and Laser Welding) or it can be the consumable electrode (as in Submerged Arc Welding, Gas Metal Arc Welding, Gas Shielded Flux Cored Arc Welding and Hybrid Laser Welding, where the arc head is a Gas Metal Arc). In some cases, the filler wire is in the form of a flux-cored wire, i.e. a wire that is hollow and filled with a flux containing components improving the performances. Slag formers are added to shield the weld pool and shape and support the weld. Iron powder is used to increase deposition rates. Powdered alloys are added to produce low-alloy deposits or improving the mechanical properties. Scavengers and fluxing agents are used to refine the weld metal.

The patent application WO00/16940 discloses that deep penetration gas tungsten arc welds are achieved using titanates such as Na₂Ti₃O₇ or K₂TiO₃. Titanate is applied to the weld zone as part of a filler wire to afford deep penetration welds in carbon steels, chromium-molybdenum steels, stainless steels as well as nickel-based alloys. The titanate compounds of WO00/16940 are used in the form of high-purity powders of about 325 mesh or finer, 325 mesh corresponding to 44 μm. To control arc wander, bead consistency, and slag and surface appearance of the weldments, various additional components may be optionally added to the titanate-based filler wire, including transition metal oxides such as TiO, TiO₂, Cr₂O₃, and Fe₂O₃, silicon dioxide, manganese silicides, fluorides and chlorides. All compounds of the flux have micrometric dimensions.

### SUMMARY OF THE INVENTION

Although the penetration is improved with the flux discloses in WO00/16940, the penetration is not optimum for steel substrates.

There is thus a need for improving the weld penetration in steel substrates and therefore the mechanical properties of welded steel substrates. There is also a need for increasing the deposition rate and productivity of the welding with flux-cored wires.

To this end, the invention relates to a flux-cored wire comprising a sheath and a flux that fills the sheath, wherein the flux comprises a titanate and a nanoparticulate oxide selected from the group consisting of TiO₂, SiO₂, ZrO₂, Y₂O₃, Al₂O₃, MoO₃, CrO₃, CeO₂, La₂O₃ and mixtures thereof.

The flux-cored wire according to the invention may also have the optional features listed below, considered individually or in combination:
the titanate is chosen from among: Na₂Ti₃O₇, NaTiO₃, K₂TiO₃, K₂Ti₂O₅, MgTiO₃, SrTiO₃, BaTiO₃, CaTiO₃, FeTiO₃ and ZnTiO₄ or mixtures thereof,
the percentage of the nanoparticulate oxide in the flux is below or equal to 80 wt. %,
the percentage of the nanoparticulate oxide in the flux is above or equal to 10%,
the nanoparticles have a size comprised between 5 and 60 nm,
the percentage of titanate in the flux is above or equal to 45 wt. %,
the diameter of the titanate is between 1 and 40 μm,
the sheath is made of steel,
the flux-cored wire further comprises microparticulate compounds selected among microparticulate oxides and/or microparticulate fluorides,
the flux-cored wire further comprises microparticulate compounds selected from the list consisting of CeO₂, Na₂O, Na₂O₂, NaBiO₃, NaF, CaF₂, cryolite (Na₃AlF₆) and mixtures thereof,
the flux-cored wire further comprises lime, silica, manganese oxide and calcium fluoride in the form of particles of micrometric and/or millimetric size.

The invention also relates to a method for the manufacture of a flux-cored wire comprising the successive following steps:
A. Mixing at least a titanate and a nanoparticulate oxide selected from the group consisting of TiO₂, SiO₂, ZrO₂, Y₂O₃, Al₂O₃, MoO₃, Cr₀₃, CeO₂, La₂O₃ and mixtures thereof,
B. Introducing the obtained mixture in a sheath of cored wire to form the flux-cored wire.

The invention also relates to a method for the manufacture of a welded joint comprising performing arc welding or laser welding on a steel material with a flux-cored wire comprising a sheath and a flux that fills the sheath, wherein the flux comprises a titanate and a nanoparticulate oxide selected from the group consisting of TiO₂, SiO₂, ZrO₂, Y₂O₃, Al₂O₃, MoO₃, CrO₃, CeO₂, La₂O₃ and mixtures thereof.

### DETAILED DESCRIPTION

The following terms are defined:
Nanoparticles are particles between 1 and 100 nanometers (nm) in size.
Titanate refers to inorganic compounds containing titanium, oxygen and at least one additional element, such as an alkali metal element, alkaline-earth element, transition metal element or metallic element. They can be in the form of their salts.

Without willing to be bound by any theory, it is believed that the flux contained in the flux-cored wire mainly modifies the melt pool physics. It seems that, in the present invention, not only the nature of the compounds, but also the size of the oxide particles being equal to or below 100 nm modifies the melt pool physics.

Indeed, the flux is melted and incorporated in the molten metal in the form of dissolved species and, if the welding technique involves an arc, in the arc in the form of ionized species. Thanks to the presence of titanate and oxide nanoparticles in the arc, the arc is constricted.

Moreover, the flux dissolved in the molten metal modifies the Marangoni flow, which is the mass transfer at the liquid-gas interface due to the surface tension gradient. In particular, the components of the flux modify the gradient of surface tension along the interface. This modification of surface tension results in an inversion of the fluid flow towards the center of the weld pool. This inversion leads to improvements in the weld penetration and in the welding efficiency leading to an increase in deposition rate and thus in productivity. Without willing to be bound by any theory, it is believed that the nanoparticles dissolve at lower temperature than microparticles and therefore more oxygen is dissolved in the melt pool, which activate the reverse Marangoni flow.

When the welding technique involves an arc, the effect of the reverse Marangoni flow combines with a higher plasma temperature due to arc constriction, which further improve the weld penetration and the material deposition rate. When the welding technique involves a laser beam, the reverse Marangoni flow contributes to the retention of a proper keyhole shape, which, in turn, prevents gas entrapment and thus pores in the weld.

Furthermore, the dissolved oxygen acts as a surfactant, improving the wetting of the molten metal on the base metal and therefore avoiding critical defects prone to appear in the weldment, such as lack of edge fusion.

Moreover, as the components of the flux make the surface tension increase with temperature, the wettability of the weld material increases along the edges which are colder than the center of the melt pool, which prevents slag entrapment.

The invention will be better understood by reading the following description, which is provided purely for purposes of explanation and is in no way intended to be restrictive.

The flux-cored wire comprises a sheath and a flux that fills the sheath.

The material of the sheath is not particularly limited in the case of the present invention. It can be steel, for example, copper-coated C—Mn steel.

The wire has usually a diameter comprised between 0.8 and 4 mm. As for the sheath, its thickness varies depending on the percent fill selected. The percent fill is the ratio of the weight of the flux ingredients or “fill” compared to the total weight of the wire.

The flux of the flux-cored wire comprises a titanate and a nanoparticulate oxide selected from the group consisting of TiO₂, SiO₂, ZrO₂, Y₂O₃, Al₂O₃, MoO₃, Cr₀₃, CeO₂, La₂O₃ and mixtures thereof. In other words, the flux comprises a titanate and at least one nanoparticulate oxide, wherein the at least one nanoparticulate oxide is selected from the group consisting of TiO₂, SiO₂, ZrO₂, Y₂O₃, Al₂O₃, MoO₃, Cr₀₃, CeO₂, La₂O₃ and mixtures thereof. This means that the flux doesn't comprise any other nanoparticulate oxide than the ones listed.

The titanate is selected from the group of titanates consisting of alkali metal titanates, alkaline-earth titanates, transition metal titanates, metal titanates and mixtures thereof. The titanate is more preferably chosen from among: Na₂Ti₃O₇, NaTiO₃, K₂TiO₃, K₂Ti₂O₅, MgTiO₃, SrTiO₃, BaTiO₃, CaTiO₃, FeTiO₃ and ZnTiO₄ and mixtures thereof. It is believed that these titanates further increase the penetration depth based on the effect of the reverse Marangoni flow. It is the inventors understanding that all titanates behave, in some measure, similarly and increase the penetration depth. All titanates are thus part of the invention. The person skilled in the art will know which one has to be selected depending on the specific case. To do so, he will take into account how easily the titanates melt and dissolve, how much they increase the dissolved oxygen content, how the additional element of the titanate affects the melt pool physics and the microstructure of the final weld. For example, NaTiO₇ is favored due to the presence of Na that improves the slag formation and detachment.

Preferably, the titanate has a diameter between 1 and 40 μm, more preferably between 1 and 20 μm and advantageously between 1 and 10 μm. It is believed that this titanate diameter further improves the arc constriction and the reverse Marangoni effect. Moreover, having small micrometric titanate particles increases the specific surface area available for the mix with the nanoparticulate oxides and have the latter further adhere to the titanate particles.

Preferably, the percentage in weight of the titanate in dry weight of the flux is above or equal to 45%, more preferably between 45% and 90% and even more preferably between 65% and 90%.

The nanoparticulate oxide is chosen from TiO₂, SiO₂, ZrO₂, Y₂O₃, Al₂O₃, MoO₃, CrO₃, CeO₂, La₂O₃ and mixtures thereof. These nanoparticles dissolve easily in the melt pool, provide oxygen to the melt pool and, consequently, improve the wettability and the material deposition and allow for a deeper weld penetration. Contrary to other oxides, such as CaO, MgO, B₂O₃, Co₃O₄ or Cr₂O₃, they do not tend to form brittle phases, they do not have a high refractory effect that would prevent the heat from correctly melting the steel and their metal ions do not tend to recombine with oxygen in the melt pool.

Preferably, the nanoparticles are SiO₂ and TiO₂, and more preferably a mixture of SiO₂ and TiO₂. It is believed that SiO₂ mainly increases the penetration depth and eases the slag removal while TiO₂ mainly increases the penetration depth and forms Ti-based inclusions which improve the mechanical properties.

Other examples of mixtures of nanoparticulate oxides are:
Yttria-stabilized zirconia (YSZ) which is a ceramic in which the cubic crystal structure of zirconium dioxide (ZrO₂) is made stable at room temperature by an addition of yttrium oxide (Y₂O₃),
A 1:1:1 combination of La₂O₃, ZrO₂ and Y₂O₃, which helps adjusting the refractory effect and promote the formation of inclusions.

Preferably, the nanoparticles have a size comprised between 5 and 60 nm. it is believed that this nanoparticles diameter further improves the homogeneous distribution of the flux.

Preferably, the percentage in weight of the nanoparticulate oxide in dry weight of flux is below or equal to 80%, preferably above or equal to 10%, more preferably between 10 and 60%, even more preferably between 25 and 55%.

According to one variant of the invention, the flux consists of a titanate and a nanoparticulate oxide selected from the group consisting of TiO₂, SiO₂, ZrO₂, Y₂O₃, Al₂O₃, MoO₃, CrO₃, CeO₂, La₂O₃ and mixtures thereof.

According to another variant of the invention, the flux can further comprise iron powder as balance. The balance can possibly represent up to 55 wt % of the flux.

According to another variant of the invention, the flux further comprises microparticulate compounds, such as microparticulate oxides and/or microparticulate fluorides, such as, for example, Na₂O, Na₂O₂, CeO₂, NaBiO₃, NaF, CaF₂, cryolite (Na₃AlF₆). Moving from nanoparticles to microparticles for some of the nanoparticulate oxides listed above alleviate the health and safety concerns related to the use of some of these oxides during the manufacturing of the wire. Na₂O, Na₂O₂, NaBiO₃, NaF, CaF₂, cryolite can be added to improve the slag formation so that slag entrapment is further prevented. They also help forming an easily detachable slag. The flux can comprise from 0.1 to 5 wt %, in dry weight of flux, of Na₂O, Na₂O₂, NaBiO₃, NaF, CaF₂, cryolite or mixtures thereof.

Having the flux contained in the sheath of the flux-cored wire is particularly advantageous compared to having the same composition applied as a coating on the substrate to be welded. First of all, the extra step of coating the substrate before welding is suppressed. Moreover, there is no need to remove the excess of coating along the weldment after welding. In this regard, the particles are also used more efficiently since all the particles provided by the flux-cored wire dissolve in the melt pool. Finally, solvents and spray mist during the coating step are avoided which is beneficial for the health and safety of the operators.

In term of process, in a first step, the titanate and nanoparticulate oxide are preferably mixed. It can be done either in wet conditions with a solvent such as acetone or in dry conditions for example in a 3D powder shaker mixer. The mixing favors the aggregation of the nanoparticles on the titanate particles which prevents the unintentional release of nanoparticles in the air, which would be a health and safety issue.

The flux thus obtained is then deposited on a thin, narrow strip which, in a previous step, has gone through forming rolls to form the strip in a U-shaped cross-section. The flux-filled U-shaped strip then flows through special closing rolls which form it into a tube and tightly compress the core materials. This tube is then pulled through draw dies to reduce its diameter and further compress the core materials. Drawing tightly seals the sheath and additionally secures the core materials inside the tube under compression, thus avoiding discontinuities in the flux.

Once a flux-cored wire according to the invention has been provided, a welded joint can be manufactured by performing arc welding or laser welding on a steel material with the flux-cored wire.

Preferably, the steel substrate to be welded is carbon steel.

The steel substrate can be optionally coated on at least part of one of its sides by an anti-corrosion coating. Preferably, the anti-corrosion coating comprises a metal selected from the group consisting of zinc, aluminium, copper, silicon, iron, magnesium, titanium, nickel, chromium, manganese and their alloys.

In a preferred embodiment, the anti-corrosion coating is an aluminium-based coating comprising less than 15 wt. % Si, less than 5.0 wt. % Fe, optionally 0.1 to 8.0 wt. % Mg and optionally 0.1 to 30.0% Zn, the remainder being Al and the unavoidable impurities resulting from the manufacturing process. In another preferred embodiment, the anti-corrosion coating is a zinc-based coating comprising 0.01-8.0 wt. % Al, optionally 0.2-8.0 wt. % Mg, the remainder being Zn and the unavoidable impurities resulting from the manufacturing process.

The anti-corrosion coating is preferably applied on both sides of the steel substrate.

The steel material can be welded to a steel substrate of the same composition or of a different composition. It can also be welded to another metal, such as for example, aluminium.

The kind of welding technique is not limited as long as it is compatible with the flux-cored wire according to the invention and used either as a filler wire feeding the weld from the side (as in Gas Tungsten Arc Welding and Laser Welding) or as a consumable electrode (as in Submerged Arc Welding, Gas Metal Arc Welding, Gas Shielded Flux Cored Arc Welding, Narrow Gap Welding and Hybrid Laser Welding, where the arc head is a Gas Metal Arc).

Depending on the welding technique, the welded zone can be covered by a shielding flux. This flux protects the welded zone from oxidation during welding. Alternatively, the welding flux of the flux-cored wire according to the present invention further comprises additional components so that the wire is suitable for self-shield welding. It preferably comprises lime, silica, manganese oxide and calcium fluoride in the form of particles of micrometric and/or millimetric size. These compounds provide the shielding effect to the flux in addition to the effects provided by the titanate and nanoparticulate oxides.

Finally, the invention relates to the use of a flux-cored wire according to the present invention for the manufacture of pressure vessels, offshore and oil & gas components, shipbuilding, automotive, nuclear components and heavy industry & manufacturing in general.

### EXAMPLES

### Example 1

A flux comprising 70 wt % MgTiO₃ (diameter: 2 μm), 10 wt % SiO₂ (diameter range: 12-23 nm) and 20 wt % TiO₂ (diameter range: 36-55 nm) was prepared and introduced in a 0.5 mm C—Mn steel sheath so as to form a wire of 1.6 mm diameter.

This flux-cored wire, identified as Sample 1, was tested, during bead-on-plate Gas Tungsten Arc welding with an intensity of 110 A and a voltage between 10.8 and 12.8V on a structural steel (C—Mn S355) whose composition is detailed in the following Table 1:

| C | Mn | Si | Al | S | P |
|---|---|---|---|---|---|
| 0.102 | 0.903 | 0.012 | 0.04 | 0.0088 | 0.012 |

During these tests, Sample 1 was compared to the following commercial wires:
Outershield® MC710-H, which is a mild steel metal cored wire supplied by Lincoln Electric®. Its sheath is filled with iron powder (Sample 2),
OK Tubrodur 15CrMn O/G, which is a flux-cored wire supplied by ESAB® and to be used for mild, low alloy and C—Mn steels (Sample 3). The exact composition of its flux is unknown.

The results obtained when using 500 mm of wire are detailed in Table 2:

| | | | Feed rate | | Weld speed |
|---|---|---|---|---|---|
| | | | increase | Weld | increase |
| | Weld | Feed rate | (compared | speed | (compared to |
| sample | time (s) | (mm/min) | to Sample 2) | (m/min) | Sample 2) |
| 1* | 216 | 136.39 | 39.9% | 44.83 | 27% |
| 2 | 301.5 | 97.46 | N.A. | 35.26 | N.A. |
| 3 | 249.5 | 116.31 | 19.3% | 37.15 | 5% |

*according to the invention

Results show that there is simultaneously a significant increase in welding speed and a significant increase in material deposition.

In addition, the widths of the deposited materials have been measured and compared. It appeared that the weld obtained with Sample 1 was in average 16% larger than the one obtained with Sample 2 and 21% larger than the one obtained with Sample 3.

It shows that the components of the flux according to the invention make the surface tension decrease with temperature so that the wettability of the weld material increases along the edges of the melt pool.

### Example 2

The effect of different welding fluxes on the welding of steel substrates was assessed by Finite Element Method (FEM) simulations. In the simulations, the fluxes comprise nanoparticulate oxides having a diameter of 10-50 nm and optionally MgTiO₃ (diameter: 2 μm). Arc welding with each flux in the form of a flux-cored wire was simulated and the results are in the following Table 3:

| | Coating composition (wt. %) | | | | |
|---|---|---|---|---|---|
| Sample | titanate | nanoparticles | | | Results |
| 4* | 50% | 40% | 10% | — | Homogeneous thermal profile. No formation of brittle |
| | MgTiO₃ | TiO₂ | YSZ | | phases. Maximum temperature in the middle of the |
| | | | | | steel. Full penetration |
| 5* | 50% | 15% | 35% | — | Homogeneous thermal profile. No formation of brittle |
| | MgTiO₃ | TiO₂ | Al₂O₃ | | phases. Maximum temperature in the middle of the |
| | | | | | steel. Full penetration |
| 6* | 50% | 15% | 35% | — | Homogeneous thermal profile. No formation of brittle |
| | MgTiO₃ | TiO₂ | MoO₃ | | phases. Maximum temperature in the middle of the |
| | | | | | steel. Full penetration |
| 7* | 50% | 15% | 35% | — | Homogeneous thermal profile. No formation of brittle |
| | MgTiO₃ | TiO₂ | CrO₃ | | phases. Maximum temperature in the middle of the |
| | | | | | steel. Full penetration |
| 8 | 50% | 15% | 35% | — | High refractory effect of CaO. Arc heat in the surface |
| | MgTiO₃ | TiO₂ | CaO | | of the plate. No full penetration |
| 9 | 50% | 15% | 35% | — | High refractory effect of MgO. Arc heat in the surface |
| | MgTiO₃ | TiO₂ | MgO | | of the plate. No full penetration |
| 10* | 50% | 15% | 35% | — | Homogeneous thermal profile. No formation of brittle |
| | MgTiO₃ | TiO₂ | CeO₂ | | phases. Maximum temperature in the middle of the |
| | | | | | steel. Full penetration |
| 11 | 50% | 15% | 35% | — | Maximum arc heat in the surface of the steel. No full |
| | MgTiO₃ | TiO₂ | B₂O₃ | | penetration. Formation of brittle phases |
| 12* | 70% | 10% | 20% | — | Homogeneous thermal profile. No formation of brittle |
| | MgTiO₃ | SiO₂ | CeO₂ | | phases. Maximum temperature in the middle of the |
| | | | | | steel. Full penetration |
| 13 | 70% | 30% Cr₂O₃ | | — | Maximum arc heat in the surface of the steel. No full |
| | MgTiO₃ | | | | penetration. Formation of brittle phases |
| 14 | 0 | 20% | 70% | 10% | High refractory effect of MgO and Co₃O₄. Arc heat in |
| | | MgO | Co₃O₄ | SiO₂ | the surface of the plate. No full penetration |
| 15 | 0 | 20% | 70% | 10% | No effect of the flux. No full penetration |
| | | MoO₃ | CeO₂ | SiO₂ | |

| | | | | |
|---|---|---|---|---|
| 16 | 70% | 30% TiN | — | No effect of the flux. No full penetration |
| | MgTiO₃ | | | |

*according to the present invention

Results show that the fluxes according to the present invention improve the penetration and the quality of the welds compared to comparative fluxes.

What is claimed is:

1-13. (canceled)

14: A flux-cored wire comprising:
a sheath; and
a flux filling the sheath, the flux including a titanate and a nanoparticulate oxide selected from the group consisting of TiO₂, SiO₂, ZrO₂, Y₂O₃, Al₂O₃, MoO₃, CrO₃, CeO₂, La₂O₃ and mixtures thereof.

15: The flux-cored wire as recited in claim 14 wherein the titanate is chosen from the group consisting of: Na₂Ti₃O₇, NaTiO₃, K₂TiO₃, K₂Ti₂O₅, MgTiO₃, SrTiO₃, BaTiO₃, CaTiO₃, FeTiO₃ and ZnTiO₄ or mixtures thereof.

16: The flux-cored wire as recited in claim 14 wherein a percentage of the nanoparticulate oxide in the flux is below or equal to 80 wt. %.

17: The flux-cored wire as recited in claim 14 wherein a percentage of the nanoparticulate oxide in the flux is above or equal to 10%.

18: The flux-cored wire as recited in claim 14 wherein the nanoparticles have a size between 5 and 60 nm.

19: The flux-cored wire as recited in claim 14 wherein a percentage of titanate in the flux is above or equal to 45 wt. %.

20: The flux-cored wire as recited in claim 14 wherein a diameter of the titanate is between 1 and 40 μm.

21: The flux-cored wire as recited in claim 14 wherein the sheath is made of steel.

22: The flux-cored wire as recited in claim 14 further comprising microparticulate compounds selected from the group consisting of microparticulate oxides and microparticulate fluorides.

23: The flux-cored wire as recited in claim 22 wherein the microparticulate compounds are selected from the group consisting of CeO₂, Na₂O, Na₂O₂, NaBiO₃, NaF, CaF₂, cryolite (Na₃AlF₆) and mixtures thereof.

24: The flux-cored wire as recited in claim 14 further comprising lime, silica, manganese oxide and calcium fluoride in the form of particles of micrometric or millimetric size.

25: A method for the manufacture of a flux-cored wire comprising the successive following steps:
mixing at least a titanate and a nanoparticulate oxide selected from the group consisting of TiO₂, SiO₂, ZrO₂, Y₂O₃, Al₂O₃, MoO₃, CrO₃, CeO₂, La₂O₃ and mixtures thereof; and
introducing the obtained mixture in a sheath of cored wire to form the flux-cored wire.

26: A method for the manufacture of a welded joint comprising: performing arc welding or laser welding on a steel material with a flux-cored wire including a sheath and a flux that fills the sheath, wherein the flux includes a titanate and a nanoparticulate oxide selected from the group consisting of TiO₂, SiO₂, ZrO₂, Y₂O₃, Al₂O₃, MoO₃, CrO₃, CeO₂, La₂O₃ and mixtures thereof.
